(19) United States
(12) Patent Application Publication
(10) Pub. No.: US 2025/0149683 A1
(43) Pub. Date: May 8, 2025

(54) SYSTEMS FOR SUPPRESSING THERMAL RUNAWAY IN BATTERY CELLS

(71) Applicant: GM GLOBAL TECHNOLOGY OPERATIONS LLC, Detroit, MI (US)

(72) Inventors: Nader E. ABEDRABBO, Rochester Hills, MI (US); James R. SALVADOR, East Lansing, MI (US); Louis G. HECTOR, JR., Shelby Township, MI (US); Erik Brandon GOLM, Sterling Heights, MI (US)

(21) Appl. No.: 18/502,666

(22) Filed: Nov. 6, 2023

(51) Int. Cl. H01M 10/6569; H01M 10/613; H01M 50/209; H01M 50/317

(52) U.S. Cl. CPC H01M 10/6569; H01M 10/613; H01M 50/209; H01M 50/317

(57) ABSTRACT

A system configured to suppress thermal runaway in a battery cell. The system includes a battery cell stack including: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; and S separators. C, A, and S are integers greater than one. A chamber is configured to store a suppressant that is configured to suppress thermal runaway. A valve is configured to open in response to a thermal runaway condition at the battery cell stack to release the suppressant from the chamber to the battery cell stack.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a system for suppressing thermal runaway in battery cells.

Electric vehicles (EVs), such as battery electric vehicles (BEVs) and hybrid vehicles, and/or fuel cell vehicles, include one or more electric machines (such as one or more motors, for example) and a battery system with one or more battery cells, modules, and/or packs. A power control system is used to control charging and/or discharging of the battery system during charging and/or driving.

### SUMMARY

The present disclosure includes, in various features, a system configured to suppress thermal runaway in a battery cell. The system includes a battery cell stack including: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; and S separators. C, A, and S are integers greater than one. A chamber is configured to store a suppressant that is configured to suppress thermal runaway. A valve is configured to open in response to a thermal runaway condition at the battery cell stack to release the suppressant from the chamber to the battery cell stack.

In further features, the battery cell is a prismatic battery cell.

In further features, the battery cell is a cylindrical battery cell.

In further features, the battery cell stack and the chamber are within a common enclosure.

In further features, the chamber is spaced apart from an enclosure including the battery cell stack, and connected to the enclosure with a conduit.

In further features, the present disclosure includes a plate within an enclosure housing the battery cell stack, the plate separating the chamber from the battery cell stack, the valve included with the plate.

In further features, the valve includes a tear seam extending along the plate.

In further features, the chamber is configured to store the suppressant as a liquid.

In further features, the suppressant is configured to vaporize upon being released from the chamber to the battery cell stack.

In further features, the suppressant includes a fluorinated ketone.

In further features, the chamber is defined by a cannister configured to be inserted into an enclosure including the battery cell stack.

The present disclosure includes, in various features, a system configured to suppress thermal runaway in a battery cell. The system includes: an enclosure; a battery cell stack within the enclosure including: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; and S separators, where C, A, and S are integers greater than one. A chamber is defined within the enclosure, the chamber configured to store a suppressant that is configured to suppress thermal runaway. A valve is configured to open in response to a thermal runaway condition at the battery cell stack to release the suppressant from the chamber to the battery cell stack.

In further features, a divider is within the enclosure, the divider partially defining the chamber and including the valve.

In further features, the divider is mounted to an inner wall of the enclosure.

In further features, the valve includes a tear seam.

In further features, the chamber is partially defined by the enclosure.

In further features, the chamber is defined by a cannister configured to be inserted into the enclosure.

The present disclosure further includes, in various features, a system configured to suppress thermal runaway in a battery cell. The system includes a battery cell stack including: C cathode electrodes each including a cathode current collector, a cathode active layer arranged on the cathode current collector, and an external connector extending from the cathode current collector; A anode electrodes each including an anode current collector, an anode active layer arranged on the anode current collector, and an external connector extending from the anode current collector; and S separators, where C, A, and S are integers greater than one. A chamber is connected to the battery cell stack by way of a conduit, the chamber configured to store a suppressant that is configured to suppress thermal runaway. A valve is configured to open in response to a thermal runaway condition at the battery cell stack to release the suppressant from the chamber to the battery cell stack by way of the conduit.

In further features, the battery cell stack is a first battery cell stack, the conduit is a first conduit, and the valve is a first valve. The chamber is connected to a second battery cell stack by way of a second conduit, and a second valve is configured to open in response to a thermal runaway condition at the second battery cell stack to release the suppressant from the chamber to the second battery cell stack by way of the second conduit.

In further features, the battery cell stack is included with one of a prismatic battery cell and a cylindrical battery cell.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side, cross-sectional view of an exemplary battery cell;

FIG. 2 is a perspective view of an exemplary prismatic battery cell;

FIG. 3 is a perspective view of an exemplary prismatic battery cell including a thermal runaway suppression system in accordance with the present disclosure;

FIG. 4 is a cross-sectional view taken along line 4-4 of FIG. 3;

FIG. 5 is a perspective view of an exemplary divider of the thermal runaway suppression system including a valve configured to control release of a suppressant;

FIG. 6 illustrates release of the suppressant through the valve;

FIG. 7A is a cross-sectional view of another exemplary prismatic battery cell including a thermal runaway suppression system in accordance with the present disclosure, the system including a cannister insert housing a suppressant;

FIG. 7B illustrates the cannister insert and an electrode stack of the prismatic battery cell in a common enclosure;

FIG. 7C is a perspective view of the cannister insert;

FIG. 7D is a cross-sectional view taken along line 7D-7D of FIG. 7C;

FIG. 8 is a cross-sectional view of an exemplary cylindrical battery cell including a thermal runaway suppression system in accordance with the present disclosure;

FIG. 9 illustrates area 9 of FIG. 8 in greater detail; and

FIG. 10 illustrates an additional thermal runaway suppression system for a prismatic cell in accordance with the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

A thermal runaway suppression system for battery cells in accordance with the present disclosure includes a suppression material configured to actively suppress thermal runaway. The suppression system prevents thermal runaway from migrating to neighboring battery cells, and allows particular cells affected by thermal runaway to be replaced without having to replace surrounding cells that have not been affected by thermal runaway. The present disclosure also potentially allows for battery pack density to be increased.

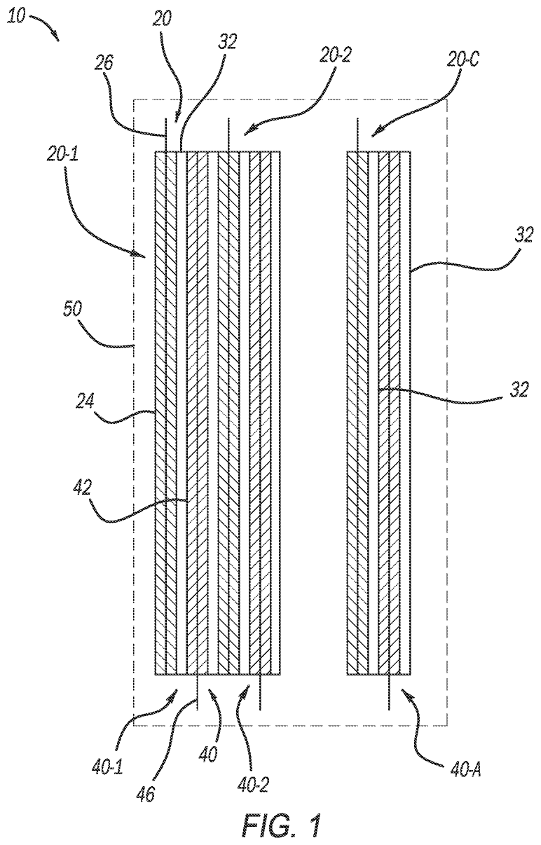

Referring now to FIG. 1, a battery cell 10 includes C cathode electrodes 20, A anode electrodes 40, and S separators 32 seated within an enclosure 50. C, A, and S are integers, which are each greater than one. In some examples, A=C+1. The C cathode electrodes, 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

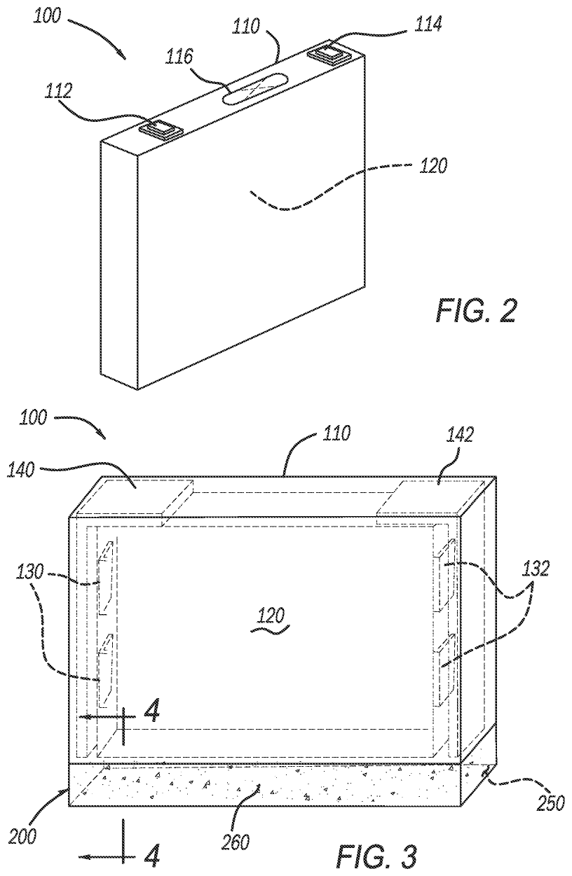

With continued reference to FIG. 1, and additional reference to FIGS. 2 and 3, a prismatic battery cell 100 includes an enclosure 110. In some examples, the enclosure 110 has a rectangular cross-section. The prismatic battery cell 100 includes external terminals 112 and 114, and a vent cap 116. A stack 120 of the C cathode electrodes 20, the A anode electrodes 40, and the S separators 32 is arranged in the enclosure 110. The anode current collectors 46 and/or the cathode current collectors 26 include external tabs 130 and 132 respectively, which are welded to internal terminals 140 and 142 respectively in any suitable manner, such as by laser welding, ultrasonic welding, etc. The internal terminals 140 and 142 contact the external terminals 112 and 114 respectively of the prismatic battery cell 100.

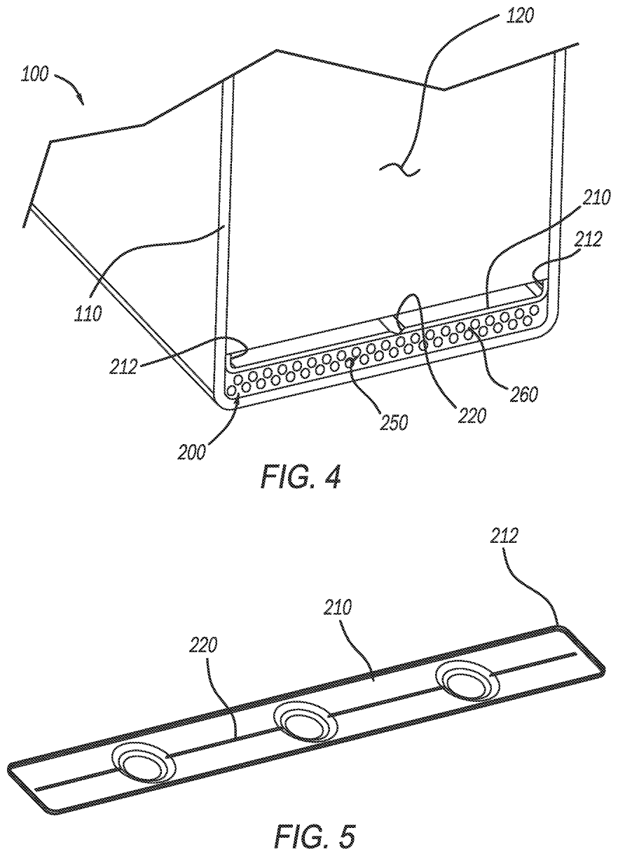

With continued reference to FIG. 3, and additional reference to FIGS. 4-6, the prismatic battery cell 100 includes a thermal runaway suppression system 200 in accordance with the present disclosure. The thermal runaway suppression system 200 includes a divider in the form of a plate 210 within the enclosure 110 adjacent to the stack 120. The plate 210 is mounted within the enclosure 110 in any suitable manner to define a chamber 250, which is configured to retain a suppressant material 260 therein. For example, the plate 210 may include a flange 212 extending around an outer perimeter of the plate 210. The flange 212 is secured to an inner surface of the enclosure 110 in any suitable manner, such as with any suitable weld, press-fit, mechanical interlock, adhesive, etc. The flange 212 may extend upward away from the chamber 250, or downward towards the chamber 250.

The plate 210 includes a valve configured to release the suppressant material 260 in response to a thermal runaway condition within the stack 120. The valve is configured to open when pressure within the stack 120 exceeds a predetermined threshold corresponding to the presence of thermal runaway to allow the suppressant material 260 to flow out of the chamber 250 into the stack 120. The valve may be configured in any suitable manner to control release of the suppressant material 260. For example, the valve may be any suitable mechanical valve, electronically controlled valve, etc. The valve can include phase change material separating the suppressant material 260 from the stack 120, and/or a shape memory alloy disc, that is temperature or pressure triggered to release the suppressant material 260 to the stack 120. In the example of FIGS. 4-7, the valve is configured as a tear seam 220.

The tear seam 220 extends along a length of the plate 210 in the example illustrated, but may be positioned in any other suitable manner as well. The tear seam 220 is formed in the plate 210 in any suitable manner. For example, the tear seam 220 may be a weakened area of the plate 210, which is configured to rupture or otherwise open when pressure within the stack 120 exceeds a predetermined threshold corresponding to the presence of thermal runaway at the stack 120 to allow the suppressant material 260 to flow out of the chamber 250 into the stack 120. The tear seam 220 may also include a bimetallic plate configured to separate or otherwise open (such as by deforming) to expose an opening in the plate 210 through which the suppressant material 260 may pass. The tear seam 220 may be configured to open in response to any suitable predetermined pressure, such as any suitable pressure less than a pressure at which the vent cap 116 is configured to open. The vent cap 116 may be configured to open at, for example, 1.0-1.5 megapascals. In one exemplary application, the tear seam 220 may be configured to open between 0.75-0.85 megapascals, or about 0.75-0.85 megapascals.

The suppressant material 260 may be any suitable material (e.g., gas, liquid, etc.) configured to suppress thermal runaway within the stack 120. For example, the suppressant material 260 may be or include perfluoro (2-methyl-3-pentanone), which is a fluorinated ketone with the structural formula CF₃CF₂C(═O)CF(CF₃)₂ and is a fully-fluorinated analog of ethyl isopropyl ketone. Perfluoro (2-methyl-3-pentanone) is supplied by, for example, 3M Company of St. Paul, Minnesota under the brand names Novec™ 1230, Novec™ 649, and FK-5-1-12. The suppressant material 260 is stored as a liquid under pressure in the chamber 250. When the valve, such as the tear seam 220, opens, the suppressant material 260 rapidly vaporizes and enters the stack 120 to suppress the thermal runaway event. More specifically, when the suppressant material 260 vaporizes it removes heat from the stack 120 to reduce the speed of thermal runaway, which gives other thermal runaway mechanisms (e.g., short circuit interrupt devices, etc.) additional time to suppress the thermal event.

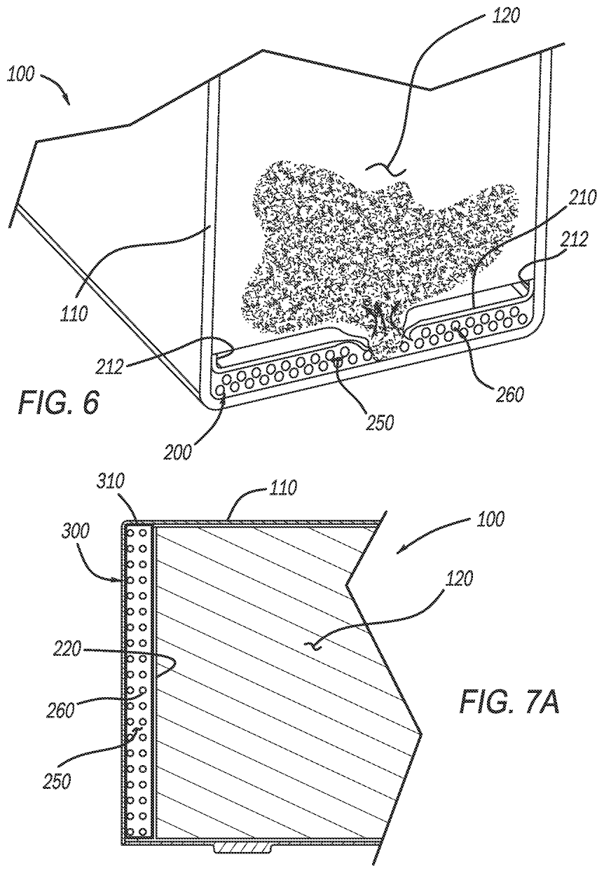

FIG. 6 illustrates exemplary operation of the suppression system 200 to suppress thermal runaway. When pressure within the stack 120 exceeds a predetermined pressure due to the presence of a thermal runaway condition, the tear seam 220 (or any other suitable valve) is configured to open to release the suppressant material 260 into the stack 120. The liquid suppressant material 260 vaporizes upon opening of the tear seam 220 and enters the stack 120 where the suppressant material 260 suppresses the thermal runaway.

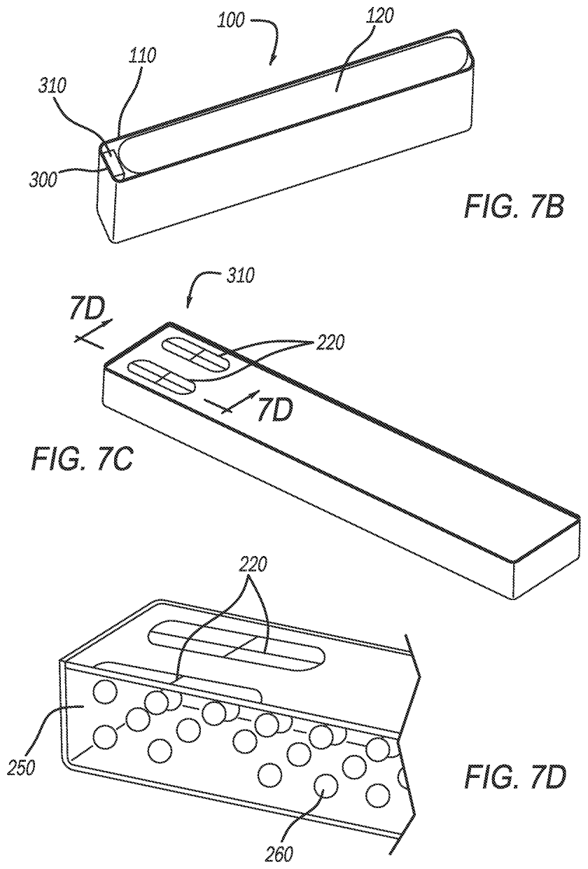

FIGS. 7A-7D illustrate another thermal runaway suppression system 300 in accordance with the present disclosure. The thermal runaway suppression system 300 includes a cannister 310, which houses the suppressant material 260. The cannister 310 includes any suitable valve for controlling release of the suppressant material 260 into the stack 120. For example, the cannister 310 may include the plate 210 (or a plate similar thereto) with the tear seam 220. The cannister 310 may include any other suitable valve configured to release the suppressant material 260 in response to an increase in pressure within the stack 120 associated with thermal runaway. The cannister 310 may be a self-contained unit, which does not incorporate any wall or other surface of the enclosure 110. The cannister 310 may thus be inserted within the enclosure 110 for suppressing thermal runaway of the stack 120. The cannister 310 may also be configured to be inserted within any other suitable enclosure to suppress thermal runaway therein.

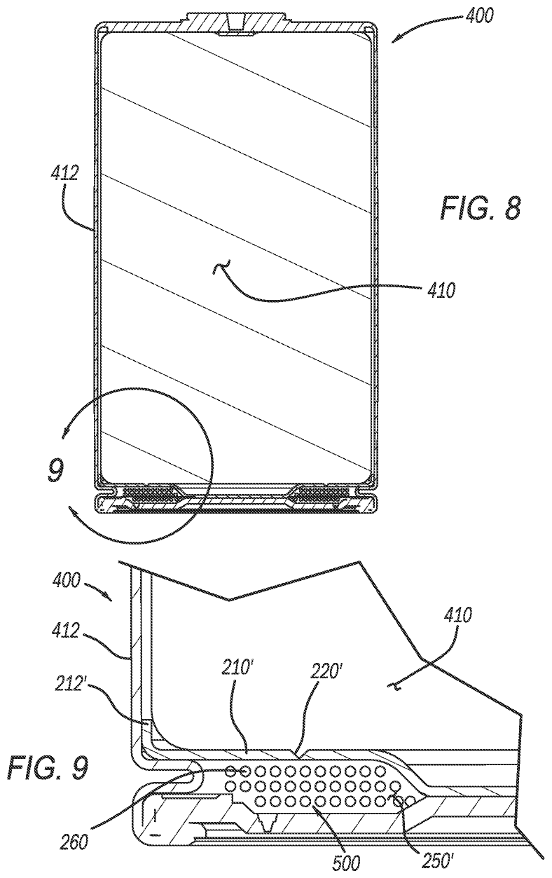

FIGS. 8 and 9 illustrate an exemplary cylindrical battery cell 400 including another thermal runaway suppression system 500 in accordance with the present disclosure. The cylindrical battery cell 400 includes a roll 410 of electrodes, cathodes, and separators, which is known as a “jelly roll.” The roll 410 is similar to the stack 120, but rolled into a cylindrical enclosure 412. Within the enclosure 412 is a plate 210′, which is similar to the plate 210 but has a cylindrical shape to fit within the cylindrical enclosure 412. Features of the plate 210′ that are the same as, or similar to, the plate 210 are designated in FIGS. 8 and 9 with the same reference numbers along with the prime (′) symbol. The description of the similar features set forth above also applies to the configuration of FIGS. 8 and 9 unless stated otherwise.

The plate 210′ includes a flange 212′, which is retained against an interior of the enclosure 412 in any suitable manner (such as by welding, press fit, mechanical interlock, adhesive, etc.) to define a chamber 250′ for the suppressant material 260, which is similar to the chamber 250 but generally circular. The plate 210′ may be arranged at any suitable location within the enclosure 412, such as towards a bottom of the enclosure 412 as illustrated in FIGS. 8 and 9. The plate 210′ includes any suitable valve to control release of the suppressant material 260 out of the enclosure 412 and into the stack 120. For example, the plate 210′ may include a valve in the form of a tear seam 220′, which is configured to open to release the suppressant material 260 in the same manner described above with respect to the tear seam 220.

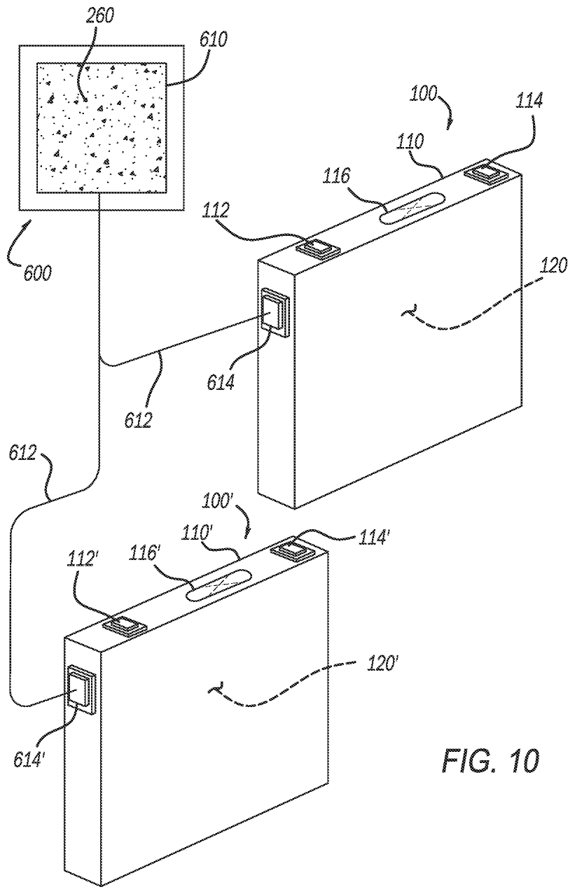

FIG. 10 illustrates an additional suppression system 600 in accordance with the present disclosure. The suppression system 600 may be configured as a replacement for the suppression system 200, the suppression system 300, and/or the suppression system 500. FIG. 10 illustrates the suppression system 600 connected to the prismatic battery cell 100 in place of the suppression system 200. The suppression system 600 may be connected to the cylindrical battery cell 400 as well.

The suppression system 600 includes a container 610, which is separate from the prismatic battery cell 100, and connected thereto by a conduit 612. The container 610 may be connected to multiple battery cells. For example and as illustrated in FIG. 10, the container 610 may be connected to another battery cell 100′ by way of the conduit 612. The container 610 is configured to hold the suppressant material 260 therein. At the prismatic battery cell 100 is any suitable valve 614, which is configured to open in response to a thermal runaway condition at the stack 120. Similarly, the battery cell 100′ includes a valve 614′. The following description of the valve 614 also applies to the valve 614′. The valve 614 may include a tear seam (such as the tear seam 220), a mechanical valve, an electronically activated valve, etc. The valve 614 is configured to open when pressure within of the stack 120 exceeds a predetermined threshold corresponding to thermal runaway, such as 0.75-0.85 megapascals, or about 0.75-0.85 megapascals. When the valve 614 opens, the liquid suppressant material 260 flows out from within the container 610 and into the stack 120 of the battery cell 100 where the suppressant material 260 vaporizes and suppresses the thermal runaway as described above. When the valve 614′ opens, the liquid suppressant material 260 flows out from within the container 610 and into the stack 120′ of the battery cell 100′ where the suppressant material 260 vaporizes and suppresses the thermal runaway.

In FIG. 9, the cylindrical battery cell 400 may also be configured with the suppression system 600 as a replacement for the suppression system 500, which would eliminate the plate 210′ and the suppressant material 260 beneath the plate 210′. For example, the conduit 612 may be connected to the valve 614 positioned at any suitable location to detect changes in pressure within the roll 410 resulting from thermal runaway within the roll 410. The valve 614 is configured to open when pressure of the roll 410 exceeds a predetermined threshold corresponding to thermal runaway, such as 0.75-0.85 megapascals, or about 0.75-0.85 megapascals. When the valve 614 opens, the liquid suppressant material 260 flows out from within the container 610 and into the roll 410 where the suppressant material 260 vaporizes and suppresses the thermal runaway as described above. The container 610 may be connected to multiple battery cells, such as multiple cylindrical battery cells to distribute the suppressant material 260 throughout the battery cells.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A system configured to suppress thermal runaway in a battery cell, the system comprising:
a battery cell stack including:
C cathode electrodes each including a cathode current collector, a cathode active layer arranged on the cathode current collector, and an external connector extending from the cathode current collector;
A anode electrodes each including an anode current collector, an anode active layer arranged on the anode current collector, and an external connector extending from the anode current collector; and
S separators, where C, A, and S are integers greater than one;
a chamber configured to store a suppressant that is configured to suppress thermal runaway; and
a valve configured to open in response to a thermal runaway condition at the battery cell stack to release the suppressant from the chamber to the battery cell stack.

2. The system of claim 1, wherein the battery cell is a prismatic battery cell.

3. The system of claim 1, wherein the battery cell is a cylindrical battery cell.

4. The system of claim 1, wherein the battery cell stack and the chamber are within a common enclosure.

5. The system of claim 1, wherein the chamber is spaced apart from an enclosure including the battery cell stack, and connected to the enclosure with a conduit.

6. The system of claim 1, further comprising a plate within an enclosure housing the battery cell stack, the plate separating the chamber from the battery cell stack, the valve included with the plate.

7. The system of claim 6, wherein the valve includes a tear seam extending along the plate.

8. The system of claim 1, wherein the chamber is configured to store the suppressant as a liquid.

9. The system of claim 8, wherein the suppressant is configured to vaporize upon being released from the chamber to the battery cell stack.

10. The system of claim 9, wherein the suppressant includes a fluorinated ketone.

11. The system of claim 1, wherein the chamber is defined by a cannister configured to be inserted into an enclosure including the battery cell stack.

12. A system configured to suppress thermal runaway in a battery cell, the system comprising:
an enclosure;
a battery cell stack within the enclosure including:
C cathode electrodes each including a cathode current collector, a cathode active layer arranged on the cathode current collector, and an external connector extending from the cathode current collector;
A anode electrodes each including an anode current collector, an anode active layer arranged on the anode current collector, and an external connector extending from the anode current collector; and
S separators, where C, A, and S are integers greater than one;
a chamber defined within the enclosure, the chamber configured to store a suppressant that is configured to suppress thermal runaway; and
a valve configured to open in response to a thermal runaway condition at the battery cell stack to release the suppressant from the chamber to the battery cell stack.

13. The system of claim 12, further comprising a divider within the enclosure, the divider partially defining the chamber and including the valve.

14. The system of claim 13, wherein the divider is mounted to an inner wall of the enclosure.

15. The system of claim 13, wherein the valve includes a tear seam.

16. The system of claim 12, wherein the chamber is partially defined by the enclosure.

17. The system of claim 12, wherein the chamber is defined by a cannister configured to be inserted into the enclosure.

18. A system configured to suppress thermal runaway in a battery cell, the system comprising:
a battery cell stack including:
C cathode electrodes each including a cathode current collector, a cathode active layer arranged on the cathode current collector, and an external connector extending from the cathode current collector;
A anode electrodes each including an anode current collector, an anode active layer arranged on the anode current collector, and an external connector extending from the anode current collector; and
S separators, where C, A, and S are integers greater than one;
a chamber connected to the battery cell stack by way of a conduit, the chamber configured to store a suppressant that is configured to suppress thermal runaway; and
a valve configured to open in response to a thermal runaway condition at the battery cell stack to release the suppressant from the chamber to the battery cell stack by way of the conduit.

19. The system of claim 18, wherein:
the battery cell stack is a first battery cell stack, the conduit is a first conduit, and the valve is a first valve; and
the chamber is connected to a second battery cell stack by way of a second conduit, and a second valve is configured to open in response to a thermal runaway condition at the second battery cell stack to release the suppressant from the chamber to the second battery cell stack by way of the second conduit.

20. The system of claim 18, wherein the battery cell stack is included with one of a prismatic battery cell and a cylindrical battery cell.
